(19) United States
(12) Patent Application Publication
(10) Pub. No.: US 2015/0184816 A1
(43) Pub. Date: Jul. 2, 2015

(54) MULTIFUNCTIONAL TORCH LIGHT

(71) Applicant: Yu-Ting HUANG, Taichung City (TW)

(72) Inventor: Yu-Ting HUANG, Taichung City (TW)

(21) Appl. No.: 14/143,645

(22) Filed: Dec. 30, 2013

(51) Int. Cl. F21L 4/04; F21V 23/04; F21V 17/12; F21V 17/02

(52) U.S. Cl. CPC F21L 4/04; F21V 17/02; F21V 23/04; F21V 17/12

(57) ABSTRACT

A multifunctional torch light includes a tube body, a barrel, a lightening assembly, a moveable sleeve, a lens assembly, a battery assembly, and a switch. Therein, the tube body has a first end and a second end. The barrel is disposed on the first end. The lightening assembly is fixed on the barrel. The moveable sleeve is rotatably disposed on the periphery of the barrel. The lens assembly is disposed on one end of the moveable sleeve and able to move in accordance with the moveable sleeve. The battery assembly is disposed inside the tube body and electrically connected to the lightening assembly. The switch is disposed on the second end of the tube body for being electrically connected to the battery assembly. Therefore, by adjusting the distance between the moveable sleeve and the barrel, wide-range diffusive illumination and long-distance concentrative illumination are both achievable.

### BACKGROUND OF THE INVENTION

1. Field of the Invention

The present invention relates to torch lights, and more particularly, to a multifunctional torch light, which is able to change the focal length, cut up ropes, and break through glass.

2. Description of the Related Art

Torch lights are common tools for illuminating and often used either in power failures due to emergency or outdoor activities.

However, conventional torch lights only possess the function of illuminating without other usages such as changing the focal length in the range of illumination for concentrating or diffusing the light beam, cutting up ropes in emergency of being obstructed by ropes, or breaking through glass of windows. Therefore, ordinary torch lights need to be improved to be a competent tool for escaping in emergency.

### SUMMARY OF THE INVENTION

To resolve such disadvantages, the present invention discloses a multifunctional torch light capable of changing the focal length, cutting up ropes, and breaking through glass, which can be used as an tool for escaping.

The present invention provides a multifunctional torch light, comprising:

a tube body, with a first end and a second end;

a barrel, disposed on the first end;

a lightening assembly, fixed on the barrel;

a moveable sleeve, rotatably disposed on the periphery of the barrel;

a lens assembly, disposed on one end of the moveable sleeve and capable of moving in accordance with the moveable sleeve;

a battery assembly, disposed inside the tube body and electrically connected to the lightening assembly; and

a switch, disposed on the second end of the tube body for being electrically connected to the battery assembly.

By optionally rotating the moveable sleeve to adjust the relative distance of the moveable sleeve against the barrel, the distance between the lens assembly and the lightening assembly thus changes, whereby the beam projected from the lightening assembly toward the lens assembly becomes either concentrated or diffused. Therefore, diffusive illumination in wide range or concentrative illumination in long distance are both achievable.

Further, a hollow connecting member is disposed between the barrel and the tube body, while the connecting member is provided with a cut groove, and a cutter corresponding to the cut groove is disposed in the connecting member. In addition, a covering member is rotatably disposed on the connecting member for optionally covering the cut groove. With such structures, when the cut groove is not covered, the cutter is able to cut up ropes or bands for effectively removing obstructions during escaping.

Still further, a base is fixed on the second end of the tube body, with a pin block pivotally connected to the base, while the pin is allowed to move between a folded position and an unfolded position. When at the unfolded position, the pin block is exposed on the outer periphery of the base for breaking through glass for escaping. Also, a slide cover is slidingly disposed on the outer periphery of the base, and capable of axially sliding between a first position and a second position. When the slide cover is at the first position, pivoting of the pin block is limited; when the slide cover is at the second position, the pin block is allowed to pivotally move from the folded position to the unfolded position.

### BRIEF DESCRIPTION OF THE DRAWINGS

FIG. 1 is a perspective view of the multifunctional torch light in accordance with the present invention.

FIG. 2 is an exploded view of the multifunctional torch light in accordance with the present invention.

FIG. 3 is a cross-sectional view taken along line 3-3 in FIG. 1.

FIG. 4 is a cross-sectional view taken along line 4-4 in FIG. 1.

FIG. 5A is a schematic view illustrating the slide cover at the first position.

FIG. 5B is a schematic view illustrating the slide cover at the second position.

FIG. 6 is a schematic view illustrating the pin block at the unfolded position.

FIG. 7A is a schematic view illustrating the multifunctional torch light in the light-diffusing status in accordance with the present invention.

FIG. 7B is a schematic view illustrating the multifunctional torch light in the light-concentrating status in accordance with the present invention.

FIG. 8A is a schematic view illustrating the multifunctional torch light with the cut groove uncovered in accordance with the present invention.

FIG. 8B is a schematic view illustrating the multifunctional torch light with the cut groove covered in accordance with the present invention.

### DETAILED DESCRIPTION OF THE INVENTION

Other and further advantages and features of the present invention will be understood by reference to the description of the preferred embodiment in conjunction with the accompanying drawings where the components are illustrated based on a proportion for explanation but not subject to the actual component proportion.

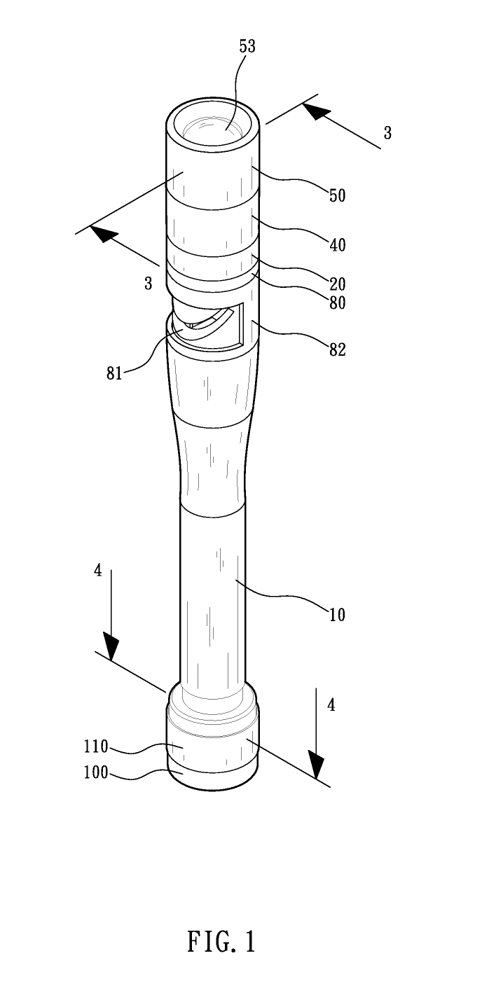

Referring to FIG. 1 to FIG. 3, a multifunctional torch light of the present invention comprises a tube body 10, a barrel 20, a lightening assembly 30, a moveable sleeve 40, a lens assembly 50, a battery assembly 60, and a switch 70. Therein, the switch 70 is a button, and the electrical connection relationship among the battery assembly 60, the switch 70, and the lightening assembly is a known art, which is not described herein.

The tube body 10 comprises a first end and a second end, wherein a hollow connecting member 80 is screwed to the first end, and the barrel 20 is screwed to the connecting member 80. The barrel 20 is provided with an outer thread 21, and the moveable sleeve 40 is provided with an inner thread 41 to be screwed to the outer thread 21, whereby the moveable sleeve 40 is allowed to rotatably move against the barrel 20. Additionally, a first ring 22 is disposed between the moveable sleeve 40 and the barrel 20 as a buffer for increasing the smoothness in between.

The lightening assembly 30 comprises a seat 31 screwed to one end of the barrel 20. A lightening member 32 is combined to the seat 31, while the seat 31 is provided with a wire hole 33 for a wire 34 to pass through. Further, one end of the wire 34 is connected to the lightening member 32, with the other end thereof electrically connected to the battery assembly 60 inside the tube body 10.

The lens assembly 50 comprises an outer sleeve 51, which is screwed to the moveable sleeve 40 and capable of move in accordance with the moveable sleeve 40. The inner edge of the outer sleeve 51 is provided with a depended part 52 for coupling a plane-convex lens 53; also, a fixing ring 54 is fixed to the inner edge of the outer sleeve 51, whereby the plane-convex lens 53 steadily contacts the depended part 52. However, by rotating the moveable sleeve 40, the distance between the plane-convex lens 53 and the lightening member 32 changes, whereby light beam projected by the lightening member 32 is allowed to be concentrated or diffused through the plane-convex lens 53.

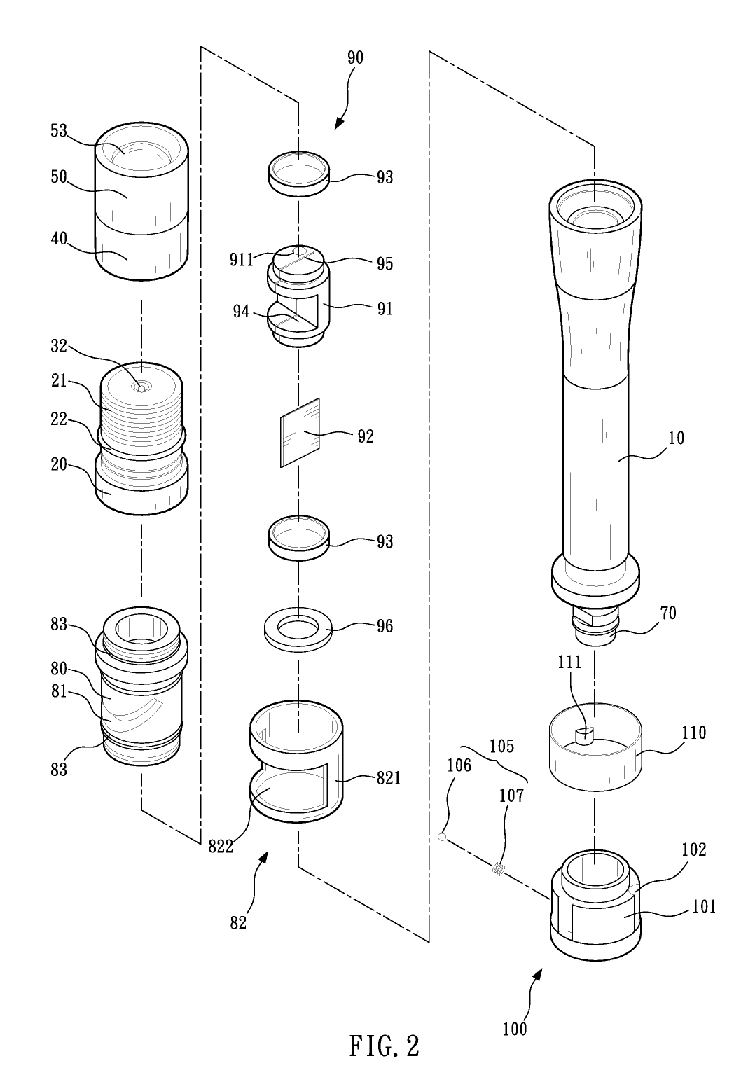

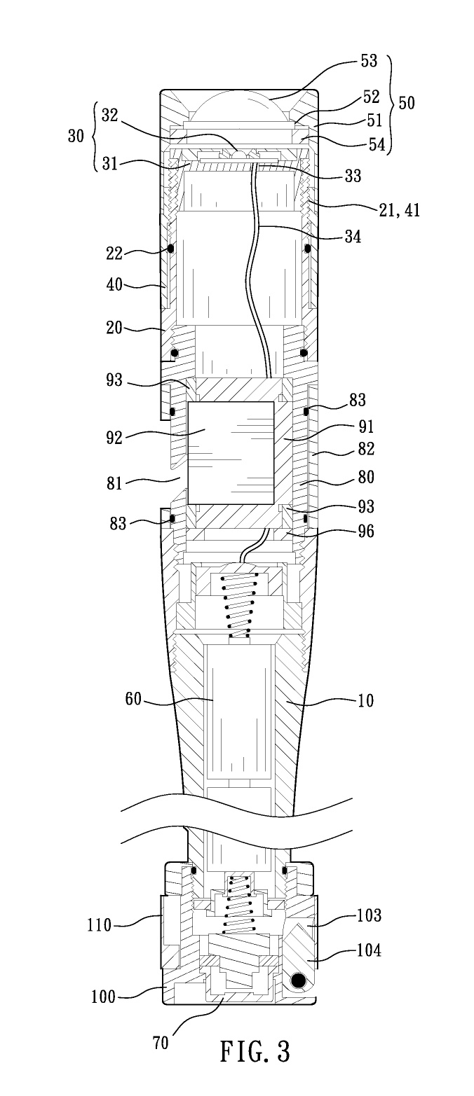

Referring to FIG. 2 and FIG. 3, the connecting member 80 is provided with an arc-shaped cut groove 81, and a cutter 90 corresponding to the cut groove 81 is disposed in the connecting member 80. Therein, the cutter 90 comprises a cutter body 91, a blade 92, and two limiting ring 93. The cutter body 91 is provided with a notch 94 and a seam 95 which is axially disposed thereon for receiving the blade 92. Therein, when the cutter 90 is disposed in the connecting member 80, the notch 94 of the cutter body 91 overlaps the cut groove 81; as a result, when the blade 92 is received by the seam 95, the blade 92 is at the same time revealed in the cut groove 81. The limiting rings 93 are fixed on the two ends of the cutter body 91, respectively, for preventing the blade 92 from detaching 91 from the cutter body 91. Especially, the cutter body 91 is provided with a through hole 911, which is in parallel to the longitudinal axis defined by the cutter body 91, for the wire 34 to pass through. For the cutter 90 to be positioned appropriately in the connecting member 80, a positioning ring 96 is disposed on one end of the cutter 90 for the cutter 90 to be fittingly fixed in the connecting member 80.

Furthermore, the peripheral surface of the connecting member 80 is rotatably provided with a barrel-shaped covering member 82, which has a covering part 821 and an open part 822 for optionally covering the cut groove 81. Therein, when the covering part 821 overlaps the cut groove 81, the blade 92 is unable to cut things; on the other hand, when the open part 822 overlaps the cut groove 81, things such as ropes are allowed to be placed in the cut groove 81 and cut by the blade 92.

Also, for facilitating the rotation of the covering member 82 against the connecting member 80, a second ring 83 is disposed in between; when needed, two second rings 83 can be disposed on two ends of the connecting member 80, respectively.

A base 100 is fixed on the second end of the tube body 10, while the switch 70 is disposed on the base 100 and electrically connected to the battery assembly 60. An outer periphery 101 of the base 100 is provided with three concaves 102 equidistantly and a recess 103. A pin block 104 is pivotally disposed in the recess 103 and capable of moving between a folded position and an unfolded position, while the pin block 104, when at the unfolded position, is able to be used for breaking through glass in emergency.

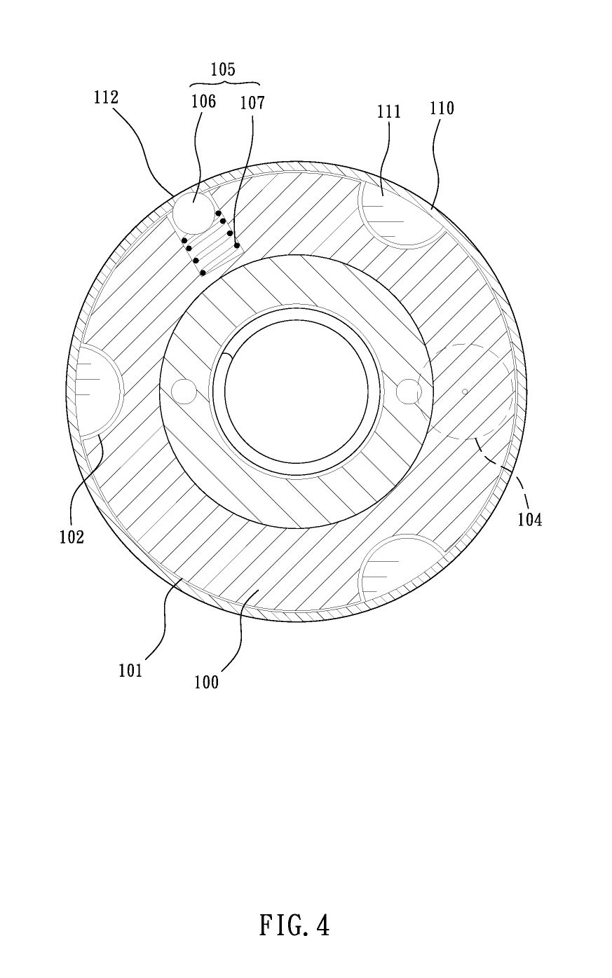

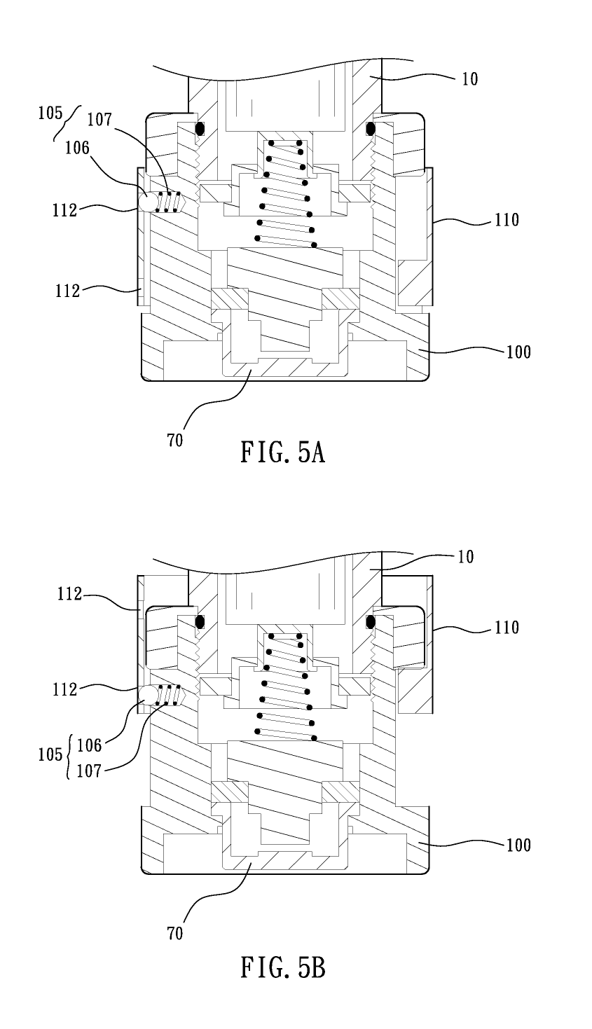

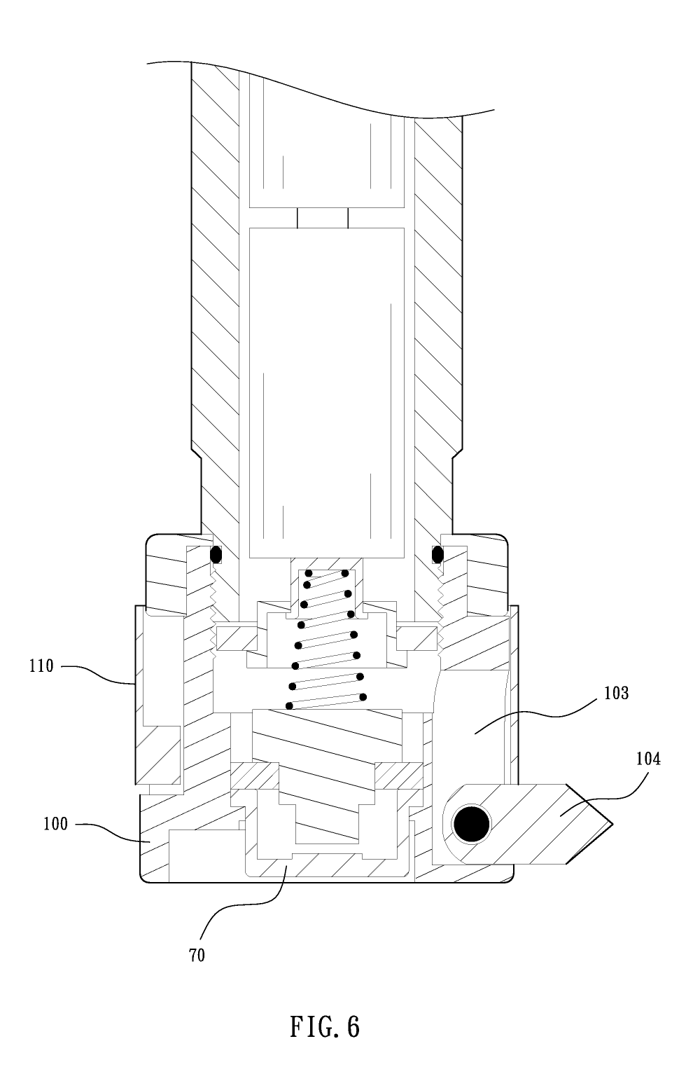

Referring to FIG. 4, a slide cover 110 is slidingly disposed on the outer periphery 101 of the base 100, while the inner edge of the slide cover 110 is provided with three protrusions 111 correspondingly for steadily coupling the concaves 102 of the base 100. As shown in FIGS. 5A and 5B, tow ends of the slide cover 110 are disposed with a positioning hole 112, respectively, and a positioning device 105, including a ball 106 and a spring member 107, is disposed between the outer periphery 101 of the base 100 and the slide cover 110, whereby the ball 106 resists against the positioning hole 112 by the force of the spring member 107, thus enabling the slide cover 110 to optionally slide along the base 100 between a first position and a second position. When at the first position, the slide cover 110 covers the recess 103, thereby hiding the pin block 104, as shown in FIG. 3; when the slide cover 110 is at the second position, the pin block 104 is allowed to move from the folded position to the unfolded position and perpendicular to the base 100 for being used, as shown in FIG. 6. The slide cover 110 herein is disposed as a protection device of the pin block 104, thereby preventing the pin block 104 from accidentally exposed and hurting users.

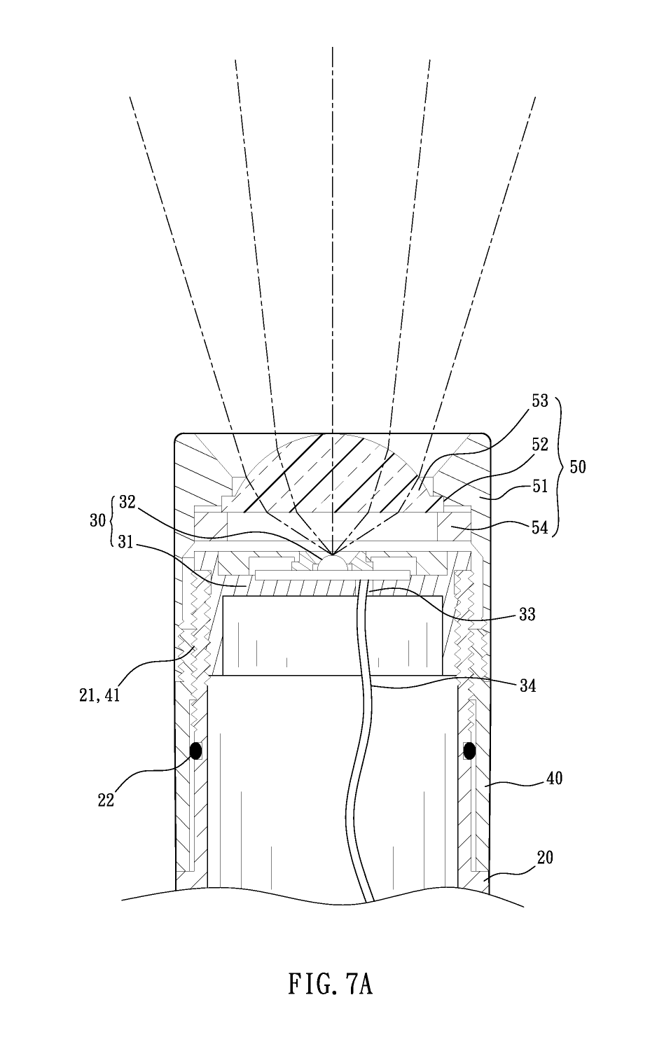

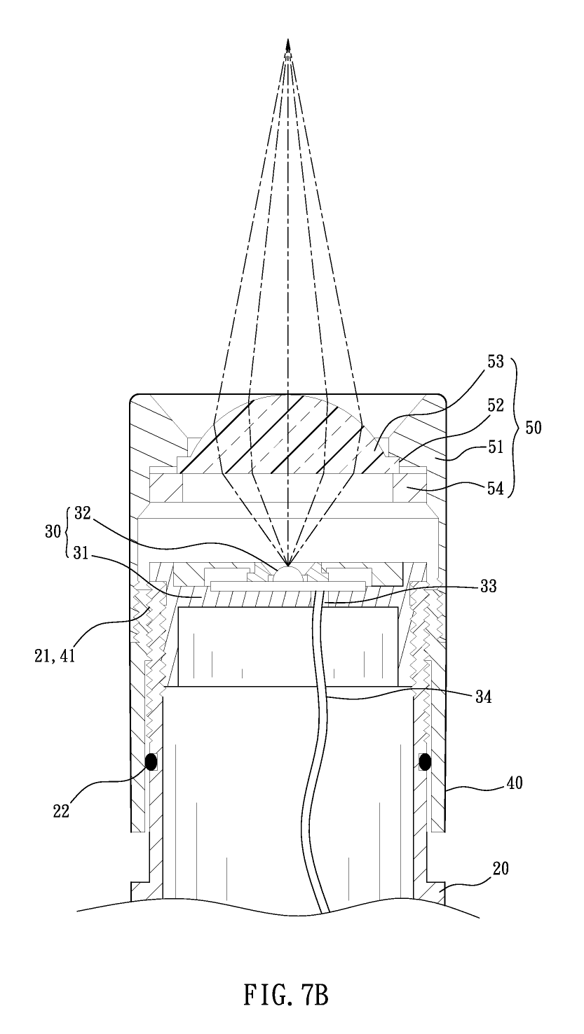

Referring to FIG. 7A, when the moveable sleeve 40 fittingly contacts the barrel 20, the distance between the lightening member 32 and the plane-convex lens 53 is at the minimum, whereby the light beam projected by the lightening member 32 toward the plane-convex lens 53 is being diffused, thus producing diffused illumination in a relatively large range.

Referring to FIG. 7B, when the moveable sleeve 40 is rotationally adjusted against the barrel 20, the plane-convex lens 53 is away from the lightening member 32 with the distance in between varied, whereby the light beam projected from the lightening member 32 toward the plane-convex lens 53 is being concentrated, thus producing a concentrated long-distant illumination in a relatively small range.

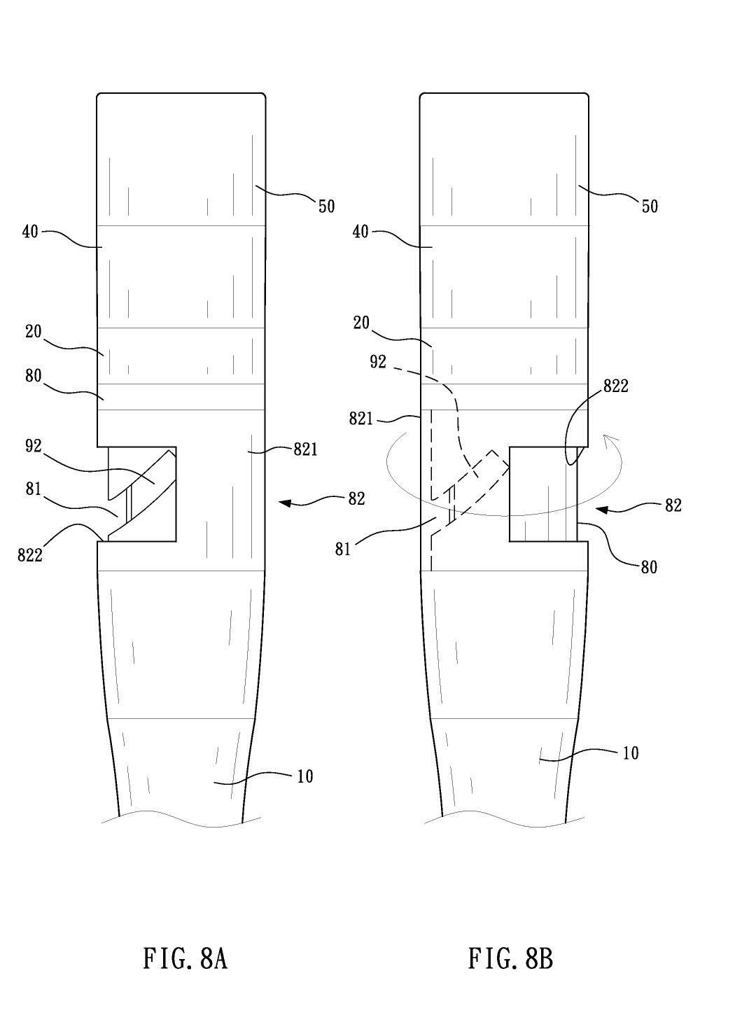

Referring to FIG. 8A, when the open part 822 of the covering member 82 overlaps the cut groove 81, the cut groove 81 is not covered; as a result, the blade 92 is revealed from the cut groove 81 and allowed to be used to cut up ropes or bands in emergency for removing such obstructions to escape.

Referring to FIG. 8B, when the covering part 821 of the covering member 82 overlaps the cut groove 81, the cut groove 81 is covered and hidden; as a result, things are not allowed to be placed in the cut groove 81 for being cut up, thereby preventing the blade 92 from accidentally cutting or hurting hands of users.

Additionally, the multifunctional torch light of the present invention possesses high structural strength, so the present invention is allowed to be used to knock tires as a tire pressure detector.

In short, the multifunctional torch light of the present invention is able to change the focal length for either concentrative illumination in long range or diffusive illumination in short range, thus enhancing the scale of application. Furthermore, the present invention is useful for escaping in emergency with capability of cutting up ropes or bands for removing obstructions and breaking through glass for escaping from hazardous sites. Therefore, the present invention improves the substantial usability of torch lights.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A multifunctional torch light, comprising:
a tube body, with a first end and a second end;
a barrel, disposed on the first end;
a lightening assembly, fixed on the barrel;
a moveable sleeve, rotatably disposed on the periphery of the barrel;
a lens assembly, disposed on one end of the moveable sleeve and capable of moving in accordance with the moveable sleeve;
a battery assembly, disposed inside the tube body and electrically connected to the lightening assembly; and
a switch, disposed on the second end of the tube body for being electrically connected to the battery assembly.

2. The multifunctional torch light of claim 1, wherein the barrel is provided with an outer thread, and the moveable sleeve is provided with an inner thread to be screwed to the outer thread.

3. The multifunctional torch light of claim 1, wherein the lens assembly comprises an outer sleeve, and the inner edge of the outer sleeve is provided with a depended part, a plane-convex lens, and a fixing ring for causing the plane-convex lens to steadily contact the depended part.

4. The multifunctional torch light of claim 1, wherein a first ring is disposed between the moveable sleeve and the barrel.

5. The multifunctional torch light of claim 1, wherein the lightening assembly comprises a seat screwed to one end of the barrel, and a lightening member is combined to the seat.

6. The multifunctional torch light of claim 5, wherein the seat is provided with a wire hole for a wire to pass through, while one end of the wire is connected to the lightening member with the other end thereof electrically connected to the battery assembly

7. The multifunctional torch light of claim 1, wherein a hollow connecting member is disposed between the barrel and the tube body, while the connecting member is provided with a cut groove, and a cutter corresponding to the cut groove is disposed in the connecting member.

8. The multifunctional torch light of claim 7, wherein a covering member is rotatably disposed on the connecting member for optionally covering the cut groove.

9. The multifunctional torch light of claim 8, wherein the covering member is present as a barrel shape and comprises a covering part and an open part.

10. The multifunctional torch light of claim 8, wherein at least a second ring is disposed between the covering member and the connecting member.

11. The multifunctional torch light of claim 7, wherein the cutter comprises a cutter body provided with a notch, a blade received by the notch of the cutter body and disposed in the cutter groove, and two limiting rings fixed on two ends of the cutter body, respectively, for preventing the blade from detaching from the cutter body.

12. The multifunctional torch light of claim 1, wherein a base is fixed on the second end of the tube body and provided with an outer periphery, while a pin block is pivotally disposed on the outer periphery and capable of moving between a folded position and an unfolded position to be exposed on the outer periphery.

13. The multifunctional torch light of claim 12, wherein the outer periphery is concavely provided with a recess for receiving the pin block.

14. The multifunctional torch light of claim 13, wherein a slide cover is slidingly disposed on the outer periphery of the base and capable of axially sliding between a first position and a second position, whereby pivoting of the pin block is limited when the slide cover is at the first position, and the pin block is allowed to pivotally move from the folded position to the unfolded position when the slide cover is at the second position.

15. The multifunctional torch light of claim 14, wherein a positioning device is disposed between the base and the slide cover, whereby the slide cover is allowed to optionally move between the first position and the second position.
